(19) United States
(12) Patent Application Publication
(10) Pub. No.: US 2018/0326640 A1
(43) Pub. Date: Nov. 15, 2018

(54) PROCESS AND ASSEMBLY FOR PRODUCING AN EXTRUDED FLEXSHAFT COVER INCORPORATED INTO A MODULAR MOTOR BRACKET

(71) Applicant: U.S. Farathane Corporation, Auburn Hills, MI (US)

(72) Inventors: Gerald N. Strich, North Branch, MI (US); Tobin Joseph Fauser, Novi, MI (US); Timothy John Brown, Bruce Township, MI (US)

(21) Appl. No.: 15/971,400

(22) Filed: May 4, 2018

Related U.S. Application Data
(60) Provisional application No. 62/505,032, filed on May 11, 2017.

(51) Int. Cl. B29C 47/00; B29C 47/10; B29C 47/88; B29C 47/78; B29C 47/90

(52) U.S. Cl. CPC B29C 47/0052; B29C 47/0023; B29C 47/1018; B60N 2002/0236; B29C 47/782; B29C 47/903; B29C 47/882

(57) ABSTRACT

A method and assembly for providing multi-stage extrusion of an article exhibiting an open interior. A multi-stage extrusion operation includes a first stage extrusion for receiving an initially extruded or otherwise pre-existing inner sleeve and extruding a surrounding sleeve and a plurality of radially projecting portions. A second stage subsequently extrudes an outer circular sleeve about the radially projecting portions. A third stage extrudes at least one wing portion to an outer edge of the outer circular sleeve.

### CROSS REFERENCE TO RELATED APPLICATIONS

The present application claims priority from U.S. Ser. No. 62/505,032 filed May 11, 2017.

### FIELD OF THE INVENTION

The present invention discloses a three stage extrusion process and assembly for producing a modular motor flex shaft cover, such as which is integrated into a powered support and guide mechanism associated with a vehicle power seat.

### BACKGROUND OF THE INVENTION

The prior art teaches a number of assemblies for creating an extruded article for various purposes. U.S. Pat. No. 9,052,039, to Mettee, teaches an extruded multiwall tubular structure formed from extrusion dies, the structure including a core having a longitudinal axis and a first wall surrounding the core. At least one form extends helically relative to the longitudinal axis and between the core and the outer wall in supporting relationship therewith. At least the first wall and the at least one form lack residual strains, as a result of stress created by the manufacturing process, subsequent the structure exiting the extrusion dies. The core is concentric with the first wall.

U.S. Pat. No. 4,157,194, to Takahashi, discloses a thermoplastic multi-walled pipe which has at least two tubular members different in inside diameter and concentrically arranged, these tubular members being spaced and supported by a plurality of ribs so as to provide hollow portions therebetween. The bond strength between the inner end surface of the rib and the tubular member supported thereby is less than that between the outer end surface of the rib and the tubular member supported thereby, so the exposure of the inner tubular member is easily achieved by means of an external force. After exposing the inner tubular member these multi-walled pipes are conveniently connected together by using a joint composed of a tubular part having the same inside diameter as the inner tubular member of the multi-walled pipe and a flange provided at one end of the tubular part concentrically therewith and having the same outside diameter as the multi-walled pipe, and in addition the hollow portion of the thermoplastic multi-walled pipe is kept sealed by the action of the flange.

U.S. Pat. No. 5,626,807, to O'Halloran, teaches a method and apparatus for making U-shaped retaining wall members and includes a combination of an extrusion die station, a calibration station, a heavy duty puller such as a tire puller and a travelling saw. The calibration station includes a series of calibration blocks which are spaced apart in an increasing fashion and controllably cooled to subject the extruded product exiting the extruding station to a controlled temperature gradient to prevent thermal shock.

### SUMMARY OF THE PRESENT INVENTION

The present invention teaches a method and assembly for creating a multi-stage extruded article exhibiting an open interior. In one variant, the article is provided as a bracket assembly and includes a first injected molded endcap and a further end injection molded motor carrier. The endcap and motor carrier each further include a motor driven gear and are secured to opposite ends of the extruded flexshaft cover which supports a drive shaft associated with the motor for operating both end gears.

The triple extrusion process includes, in succession, an innermost low frictional coefficient and high sound insulating first sleeve (such as a Nylon 12), with a second stage multiple (two, three, four or more) chamber outer shell, the shell being of a cheaper material, such including but not limited to a thermoplastic such as without limitation a forty percent polypropylene calcium carbonate filled (PP40% CA). A third and final extrusion stage can include extruding a pair of lateral wings onto the second stage outer shell (such as within which are formed accessory holes) along with an optional outer edge tab extruded onto the shell for providing additional vehicle floor support.

Additional features include a pre-extrusion operation for extruding the inner sleeve of a nylon material. A cooling station further succeeds each individual extrusion stage. The cooling station following the second stage extrusion may further include a vacuum sizing operation incorporating a sizing tube within which is passed the extrusion.

Other features include the provision of a puller station following the third stage extrusion. A post extrusion cutter operation is provided for sectioning the completed extrusion into desired lengths. Other features include the third stage extrusion forming a pair of opposite extending wing portions. A plurality of apertures may be configured within each of the wing portions.

The third stage extrusion further includes mounting a support tab upon an exterior of the outer circular sleeve. The inner sleeve can be produced from a Nylon 12 material. The first, second and third stage extrusions may also be supplied with the 40% calcium polypropylene material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an overall view of an assembly including three consecutive die extrusion stations for producing an elongated and extruded flex shaft cover according to one non-limiting embodiment of the present invention;

FIG. 2 is an illustration of an extruded flex shaft cover in produced in accordance with the extrusion process and assembly and further illustrating a pair of injection molded end cap and injection molded motor carriers which are engaged to opposite ends of the flex shaft cover;

FIG. 3 is an end view of the extruded flex shaft cover of FIG. 2;

FIGS. 4A-4E present a series of perspective, partial and cutaway views of a multi-stage extrusion produced flex shaft cover in combination with a first end attached injection molded end cap and opposite second end attached injection molded motor carrier;

FIG. 5 is an environmental illustration of a beginning location of the overall view of FIG. 1 and depicting an unreeling location for drawing pre-extruded tubing from a spool prior to delivery to a first cross head die extrusion stage or, alternately, a pre-extrusion stage for producing a continuous sleeve prior to subsequent and multiple stage extrusions;

FIG. 6 is a succeeding environmental illustration depicting a plasticized (nylon) tube being fed into a first of three successive cross head dies, such following unreeling or pre-extrusion of the tube, the cross head die providing for extrusion of a sleeve layer around the tube of such as a 40% calcium polypropylene, along with extrusion of any number of outwardly radially directed supports;

FIG. 7 is a further succeeding illustration of a second cross head die location of the multi-stage extrusion process and assembly for forming the outer concentric wall of the flex shaft cover about the previously extruded and radially directed supports, along with a downstream located vacuum tank for assisting in sizing an outer diameter of the outer concentric wall;

FIG. 8 is a succeeding downstream illustration of the vacuum tank associated with the second stage cross head die and which provides for fluidic immersion and vacuum forming of the concentric outer tube, such within a brass sizing tube secured within the tank;

FIGS. 8A-8B respectively present inlet and outlet illustrations of the second stage cross head die for forming the concentric outer tube;

FIGS. 8C-8D respectively present inlet and outlet illustrations of the post second stage vacuum forming tank;

FIG. 9 is a succeeding environmental illustration upstream of a third cross head extrusion die for forming a pair of lateral wings upon the outer concentric tube, such providing support for attached wiring associated with the electric drive motor as well as facilitating securing of the injection molded end cap and motor carrier; and

FIGS. 10A-10D illustrate, successively and in cross section, the flex shaft cover at each succeeding extrusion stage.

### DETAILED DESCRIPTION OF THE PREFERRED EMBODIMENTS

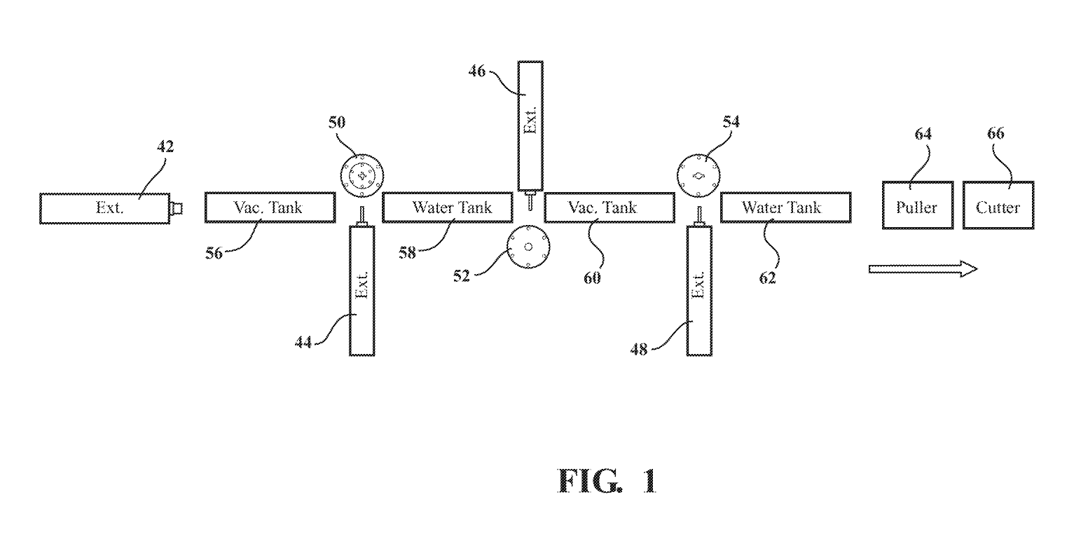

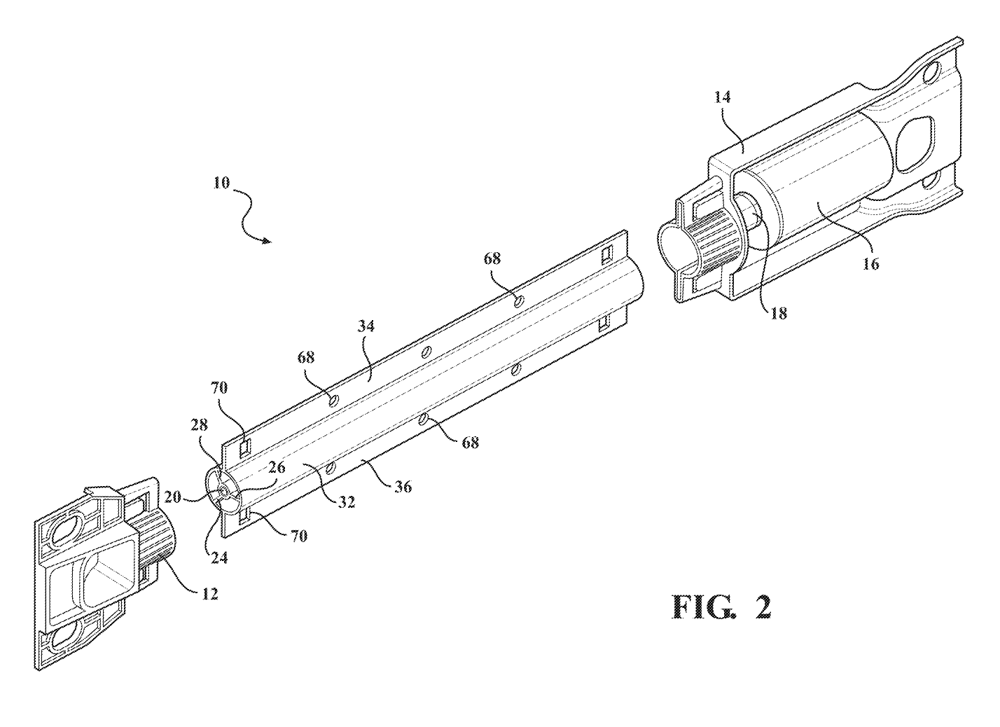

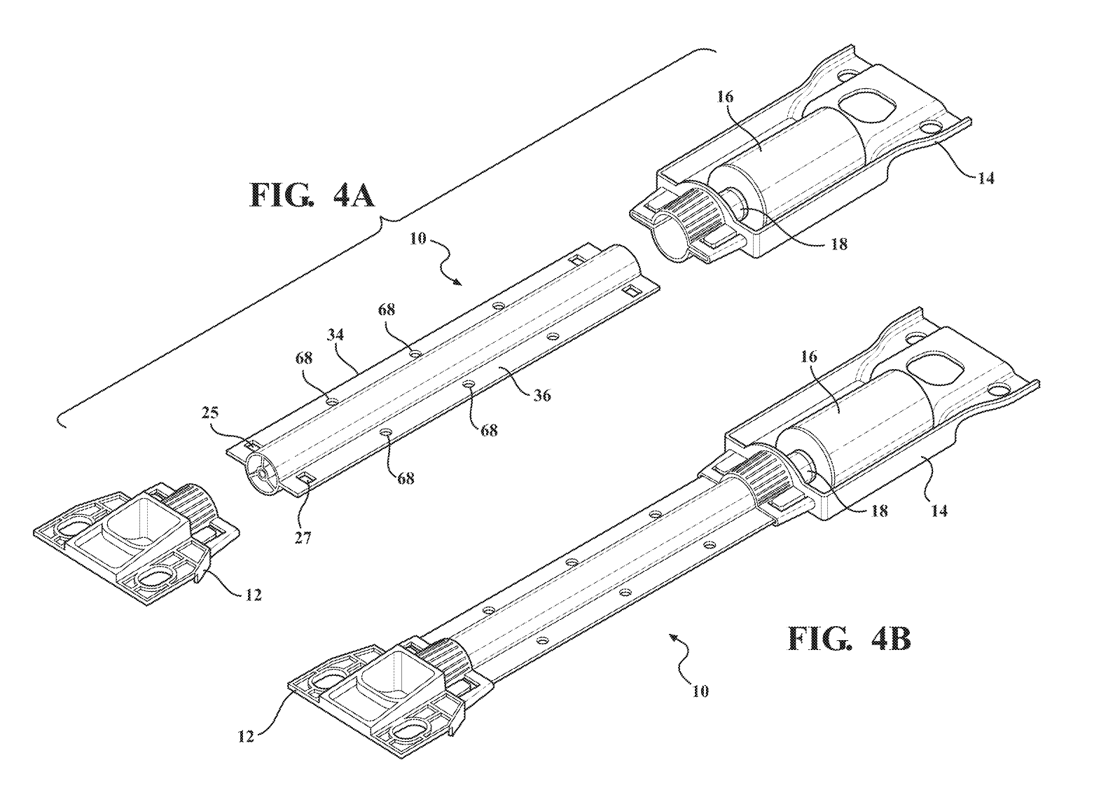

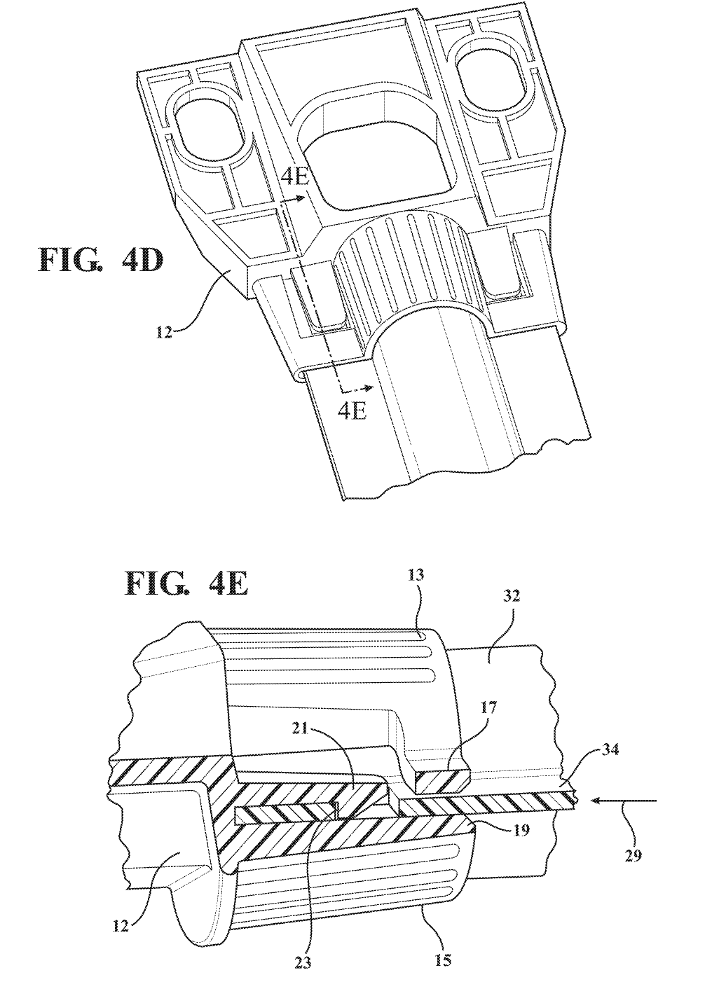

Referring now to FIGS. 1-10D, the present invention discloses a three stage extrusion process, assembly and produced article for a modular motor flex shaft cover (see as described below at 32-36), as further depicted in overall fashion at 10 in combination with end caps 12 and 14 in each of FIGS. 2-4. As best shown in FIGS. 2 and 4, the flex shaft cover is provided in combination with a pair of (typically injection molded) end caps, and such as which is integrated into a powered support and guide mechanism associated with a vehicle power seat.

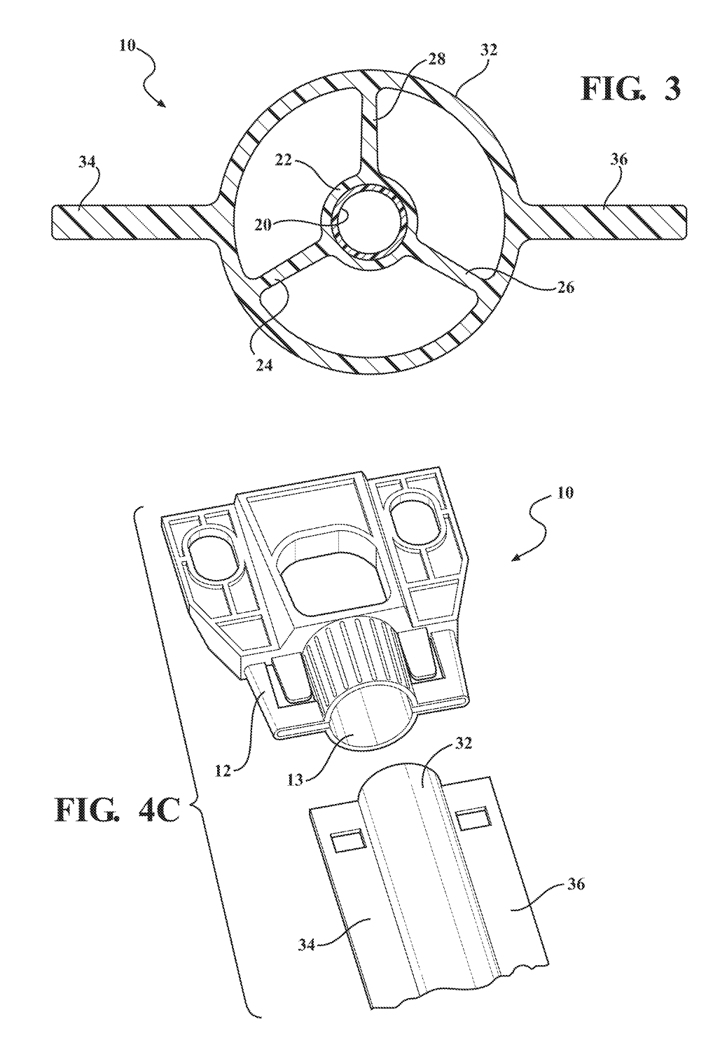

In combination with the illustration of the extruded flex shaft cover (also shown in FIG. 2 produced in accordance with the extrusion process and assembly, further illustrated are a pair of a first injection molded end cap 12 and a second injection molded motor carrier 14, which are engaged to opposite ends of the flex shaft cover by virtue of the unique geometry associated with the cross sectional profile of the multi-stage extruded flex shaft cover (see in particular FIG. 3 in combination with FIGS. 4A-4E) relative to the opposing receiving pockets or cavities configured within the respective plastic injection molded end caps 12 and 14. FIGS. 4A-4E further present a series of perspective, partial and cutaway views of a multi-stage extruded flex shaft cover 10 in combination with the first end attached injection molded end cap 12 and the opposite second end attached injection molded motor carrier 14.

FIG. 4C depicts in exploded fashion the mating arrangement between the end profile of the flex shaft cover and the receiving profile (see at 13) associated with the injection molded end cap 12. The end injection molded carrier 14 in turn receives an electric motor 16. The first endcap 12 and second motor carrier end cap 14 each further include a motor driven gear and are secured to opposite ends of the extruded flex shaft cover 10, which supports a drive shaft (largely hidden from view with a portion thereof visible at 18 extending from an outlet location of the motor 16 supported upon the carrier 14) associated with the motor for operating both end gears.

FIG. 4E is an enlarged partial view taken along circular section from FIG. 4C and further depicting the installation of the extruded motor shaft covering (see as further described below with outer sleeve 32 and pair of lateral wings 34 and 36). The first end cap 12 in the enlarged partial view of FIG. 4E further depicts a main body from which extend a pair of portions 13 and 15, these further defining therebetween a pocket for resistively seating the end of the motor shaft cover sleeve 32 and wings 34/36.

Further depicted in FIG. 4E are lateral edge extending pincer locations, these shown at 17 for extending portion 13 and further at 19 for extending portion 15. A pincer beam 21 extends from a side edge of the main body 12 between the main body of the first end cap 12, between the extending portions 13/15. The pincer beam is, along with the cap 12 and the extending portions 13/15, constructed of a resilient plasticized material and includes a tapered forward end having an inside vertical shoulder 23.

The lateral wings 34/36 extending from the extruded outer cover sleeve 32 each further include rectangular end apertures (see inner perimeter defined windows 25 and 27 at selected end in FIG. 4A opposing the first end cap 12). Upon displacing the sleeve 32 and wings 34/36 in the direction represented by arrow 29 in FIG. 4E, the tapered forward end of pincer beam 21 is deflected upwardly and, upon aligning with the windows 25/27 in the cover shaft wing portions 34/36, snap downwardly in place to resistively engage the extruded motor shaft cover to the end cap. A similar arrangement of end apertures are depicted in the extending wings of the motor shaft cover opposing the second motor bracket 14 and a similar engagement structure is integrated into the second bracket 14.

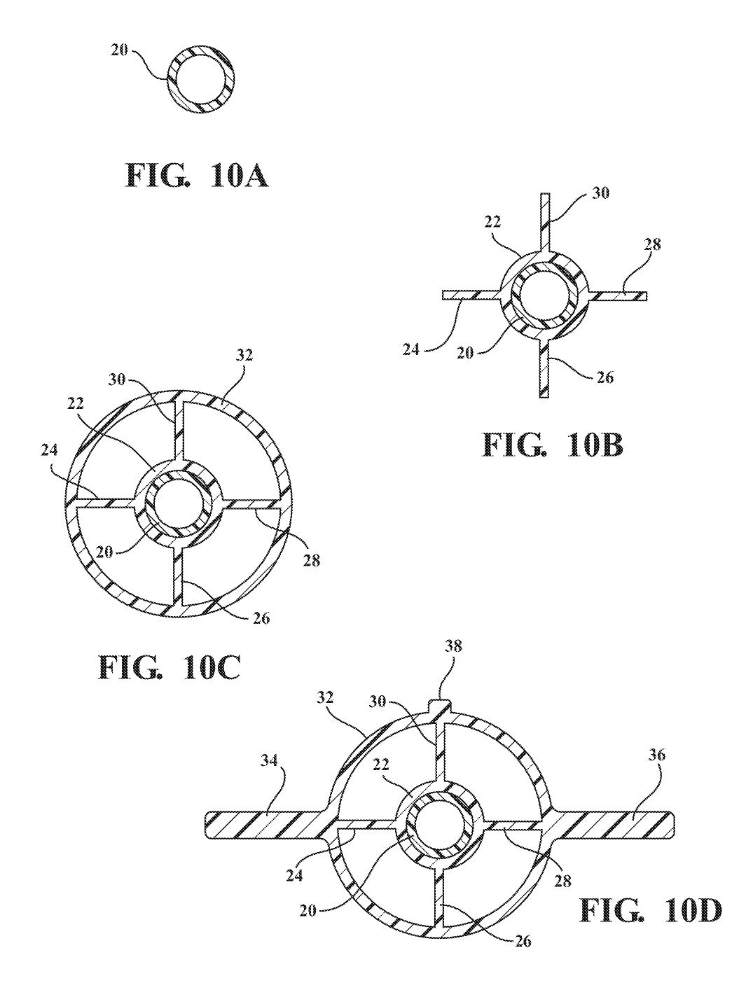

As will be described in further detail with reference to the various extrusion stages, the triple extrusion process includes, in succession, initially pre-extruding (or providing in spooled unreeling form) an innermost low frictional coefficient and high sound insulating first sleeve (Nylon 12 referenced in disclosure) which is depicted at 20 in FIG. 10A. The Nylon 12 is currently used in the production of flex-shaft cover extrusions owing to its low coefficient of friction and superior sound dampening qualities. A succeeding extrusion stage (FIG. 10B) forms an outer concentric layer 22 about the inner (Nylon 12) layer 20, along with any number of radial projecting rib locations (see at 24, 26, 28 in FIG. 3 and further at 24, 26, 28 and 30 in FIG. 10B-10D).

A further succeeding (second or third stage depending upon whether an initial pre-extrusion stage is incorporated for forming the inner sleeve 20) extrusion forms the outer concentric outer sleeve 32 about the radial extending supports 24-30. Following that, a final extrusion stage can include extruding the pair of lateral wings 34 and 36 onto the second stage outer shell 32 (such as within which are formed the rectangular windows 25/27 for engaging to the end brackets 12/14 as depicted in FIG. 4E).

Also provided are pluralities of circular holes (also subsequently described at 68) configured in spaced apart fashion along each of the wings 32/34, as depicted in FIGS. 4A-4B (such as for receiving wiring, zip ties and the like) along with an optional outer edge tab 38 extruded onto the outer shell 32 (depicted in inverted position in FIG. 10D) such having a flat exterior profile for providing additional floor support when mounted within the vehicle. The extrusion stages of FIGS. 10B-10D are understood to employ a cheaper material (PP40% CA) and as opposed to the higher quality nylon employed in the pre-extrusion of the inner tube 20 (this again providing the interior support to the motor carrier shaft 18 shown in FIGS. 4A-4B).

As previously described, FIG. 1 is an overall view of an assembly including three consecutive die extrusion stations for producing the elongated and extruded flex shaft cover 10 according to one non-limiting embodiment of the present invention and as best depicted in end profile in FIG. 3. As previously explained, the assembly contemplates the inner tube 20 (e.g. again a Nylon 12 or other suitable higher quality material for providing any combination of acoustic insulation, such considerations including the inner motor drive shaft rotating at speeds of up to 3200 rpm, and incidental contact protection in response to the turning of the motor drive shaft 18 within the interior of the flexshaft cover).

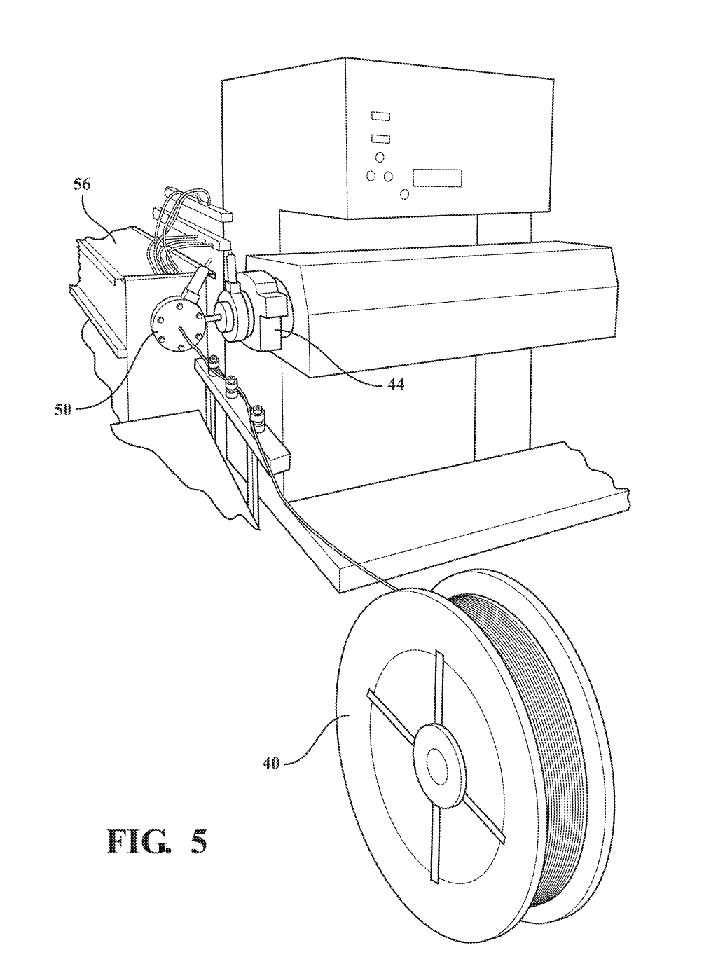

Alternative to providing the nylon tube 20 as a pre-extruded coil supported upon a drum or spool (at 40 in FIG. 5) it is envisioned that an initial or pre-extruder station (see at 42 in FIG. 1) can be provided for initially forming the nylon or other higher quality plastic inner tube 20. In combination with the environmental views of FIGS. 5-10, the assembly contemplates the provision of three independent extrusion stages, see representations at 44, 46 and 48 respectively with corresponding cross head die depictions 50, 52 and 54.

A collection of water cooling and/or vacuum tanks or stations are provided following each of the optional pre-extrusion station 42 and/or the first 44, second 46 and third 48 main extrusion stations. FIG. 5 is an environmental illustration of a beginning location of the overall view of FIG. 1 and depicting the unreeling location for drawing pre-extruded tubing 20 from the spool 40, and prior to delivery to the first cross head die extrusion stage (see again station at 44 with die head 50). Alternatively, and as previously described, a pre-extrusion stage (at 42 in FIG. 1) can be integrated into the assembly line for producing a continuous sleeve (inner nylon tube 12), prior to the subsequent and multiple stage extrusions 44, 46 and 48, the pre-extruded inner tube 12 being translated through a first cooling/vacuum tank 56 in order to sufficiently cool and solidify the same prior to passing through the first of the main extrusion stations 44 with associated cross head die arrangement 50.

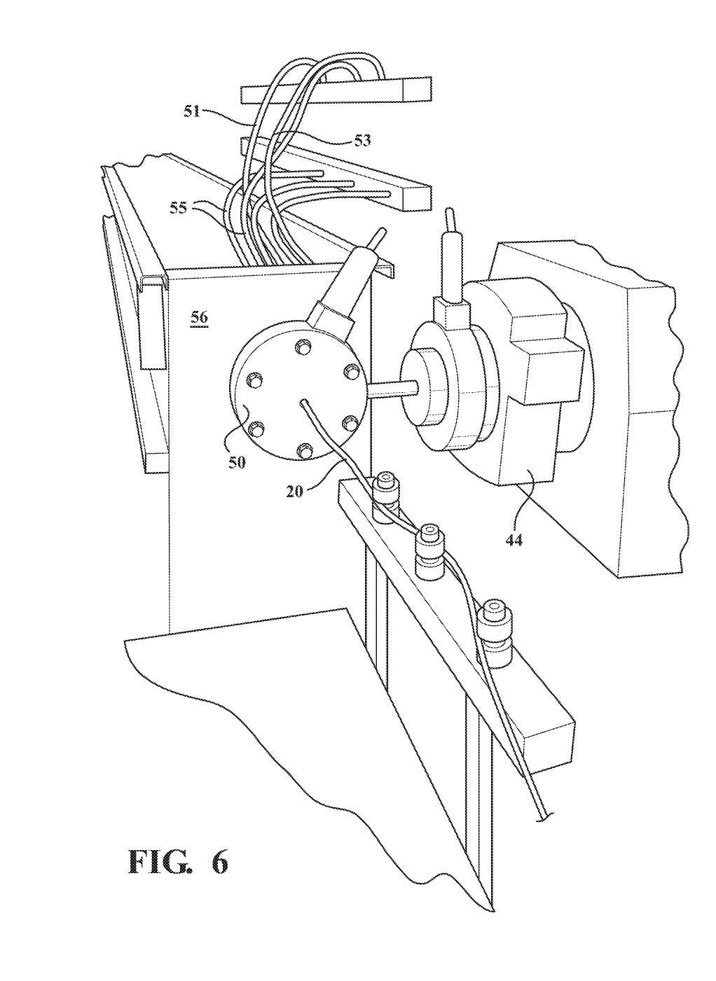

FIG. 6 is a succeeding environmental illustration depicting the plasticized (nylon) tube 20 (whether pre-extruded at station 42 of supplied upon a spool 40), being fed into the first 50 of three successive cross head dies, the cross head die providing for extrusion of the sleeve layer 22 depicted in FIG. 11B around the tube 20, such as a 40% calcium polypropylene composition, and along with the extrusion of any number of the outwardly radially directed supports (these again including four radially extruded supports 24, 26, 28 and 30 in the cross sectional depiction of the alternate variant of FIG. 11B or, alternatively, only three such supports at 24, 26 and 28 in the alternate design of FIG. 3). The cooling tank again depicted at 56 is in communication with an outlet of the cross head die 50, each cooling tank depicted and described herein being understood to provide any combination of fluid immersion or fluid spray technology for sufficiently cooling and solidifying a previously extruded component and in order to maintain a desired shape or profile during the individual and aggregating extrusion processes.

For purposes of each of the die extrusion stages, the present invention contemplates any arrangement of molten plasticized feed lines (such being shown 51, 53, 55, et seq. in FIG. 6 in relation to first main cross head die 50) and for communicating with any arrangement of dies/templates which are integrated into each of the succeeding cross head stations 44/50, 46/52 and 48/54. These provide for the successive and aggregating extrusion of each profile as shown (optionally at 42 for inner tube 20) as well as in each of FIGS. 10B, 10C and 10D corresponding to the main extrusion stations.

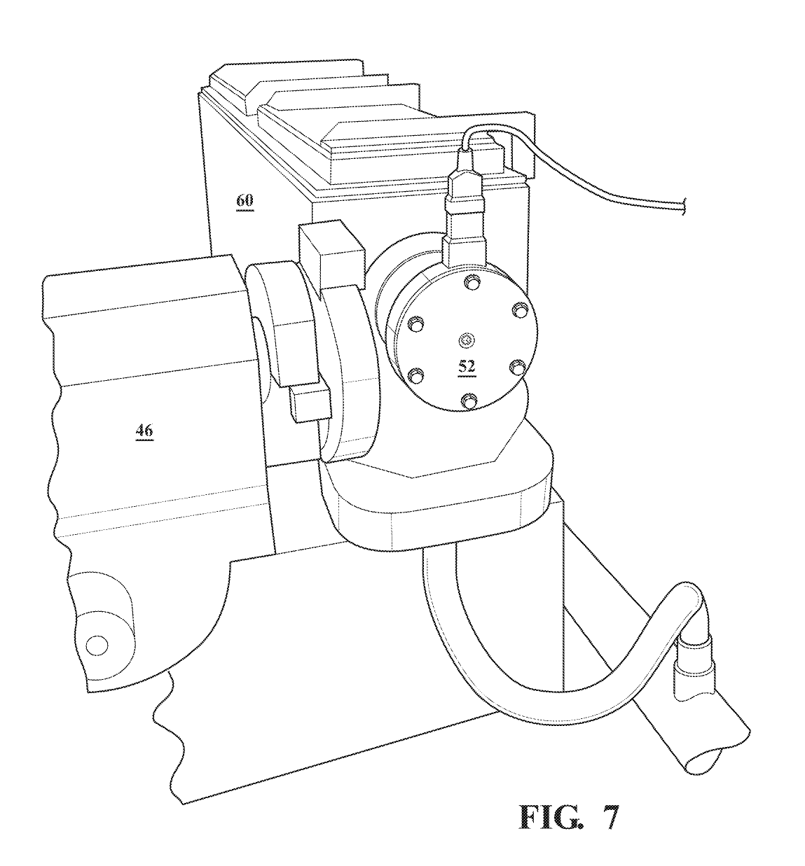

FIG. 7 is a further succeeding illustration of the second cross head die 52 (in communication with second extruder 46) of the multi-stage extrusion process and assembly, again for forming the outer concentric wall 32 of the flex shaft cover about the previously extruded and radially directed supports (e.g. 24, 26, 28 and 30). Also depicted is a downstream located vacuum tank 60 for assisting in sizing an outer diameter of the outer concentric wall 32.

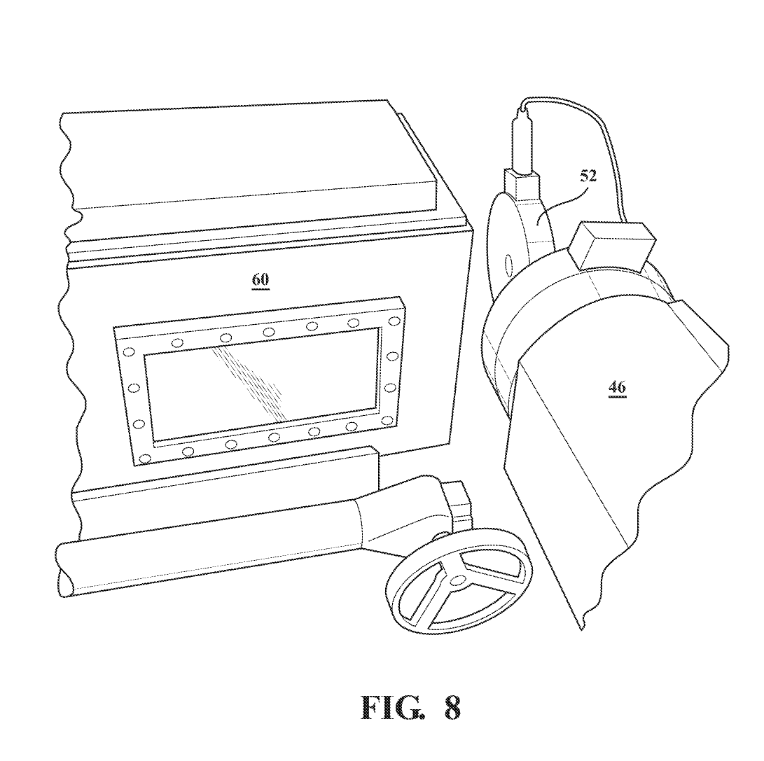

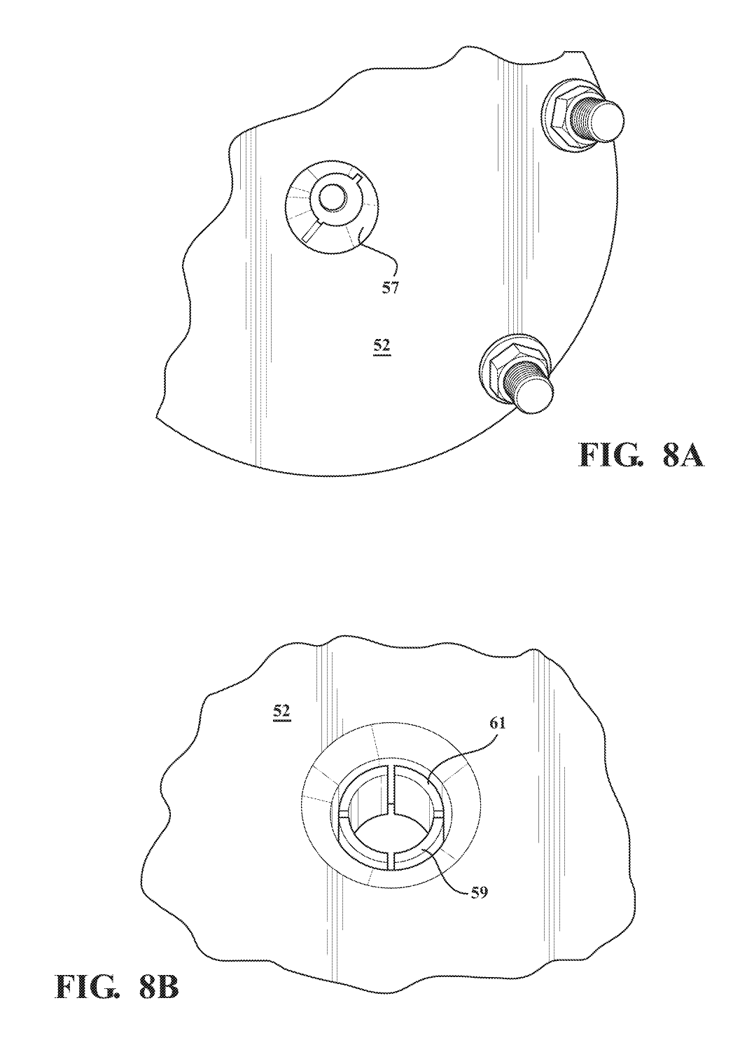

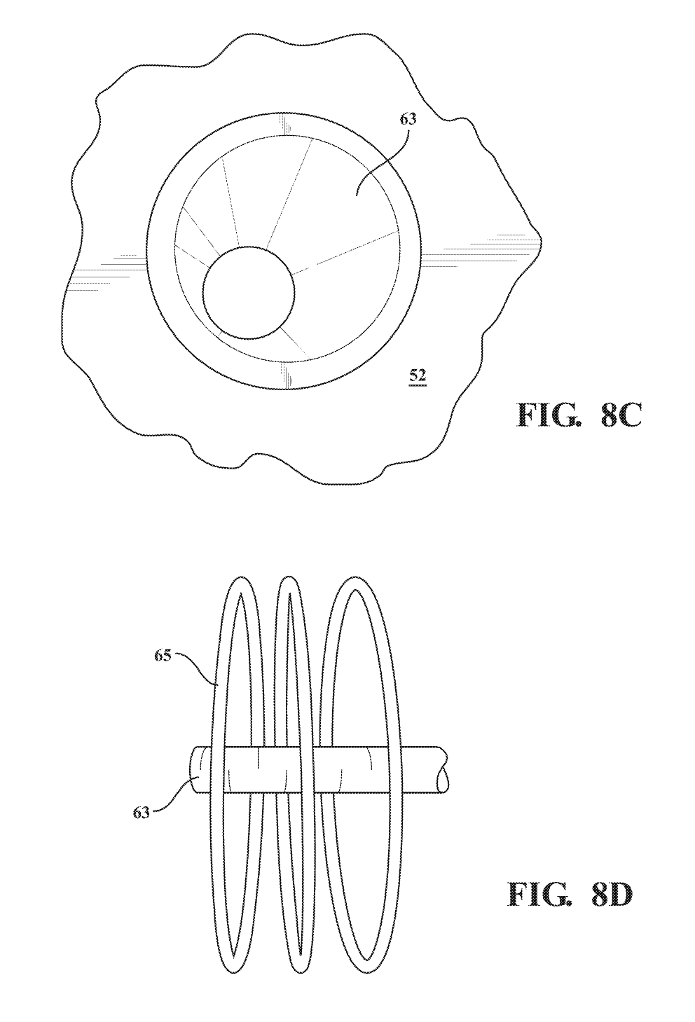

FIG. 8 is a succeeding downstream illustration of the vacuum tank 60 associated with the second stage cross head die 52, and which provides for fluidic immersion and vacuum forming of the concentric outer tube 32, such occurring within a brass sizing tube (not shown) which is secured within the tank 60 and through which is transited the intermediate extruded profile best depicted in FIG. 10B so that the radial wings 24-30 are positioned in equidistantly inner spaced proximity to the inner circular guide wall of the sizing tube, and such that the vacuum aspects of the tank 60 provide for effective drawing of the extruded outer concentric layer 32 against the inside of the guide wall, such defining an outer (or 00D) diameter of the outer circular tube 32 being extruded at this stage. As further described, the vacuum tank 60 can concurrently provide for partial cooling/solidifying of the outer extruded tube 32, such by immersing the cross sectional extruded profile of FIG. 10C within a fluid layer filling the interior of the tank 60. Alternatively, an arrangement of spray nozzles can be arranged for strategically cooling the profile as it passes through the tank.

FIGS. 8A-8B respectively present inlet and outlet illustrations of the second stage cross head die 52 for forming the concentric outer tube 32. As depicted in the inlet side facing view of FIG. 8A, an inlet pattern 57 depicted receives the semi-extruded shape of FIG. 10B (this pattern including the inner circumference for seating the inner circumferential layer 22 and outer radial projecting legs 24-30. The outlet facing side of FIG. 8B exhibits an exit pattern 59 associated with the successive extrusion stage and including an outermost annular ring aperture 61 which is in communication with the radial slots (again for radial legs 24-30) and in order to extrusion form the outer concentric tube 32 in secured fashion to exterior edges of the previously extruded radial legs.

FIGS. 8C-8D respectively present inlet and outlet illustrations of the post second stage vacuum forming tank 60. As best shown in FIG. 8C, the inlet includes a sizing tube 63 which is dimensioned to receive the OOD (outer diameter) of the outer concentric extruded shape from the second stage cross head die 52. The sizing tube (such as a brass or other suitable construction) is configured to provide highly accurate sizing of the extruded outer concentric 32 during transit through the cooling tank 60. As further depicted in FIG. 8D, the sizing tube 63 is again shown in extending fashion within an interior of the cooling tank 60, this in combination with an outer spiral wound spray hose 65 for providing a desired cooling profile to the extrusion corresponding to the profile of FIG. 10C and prior to final stage extrusion for forming the outer and lateral extending wings 34/36.

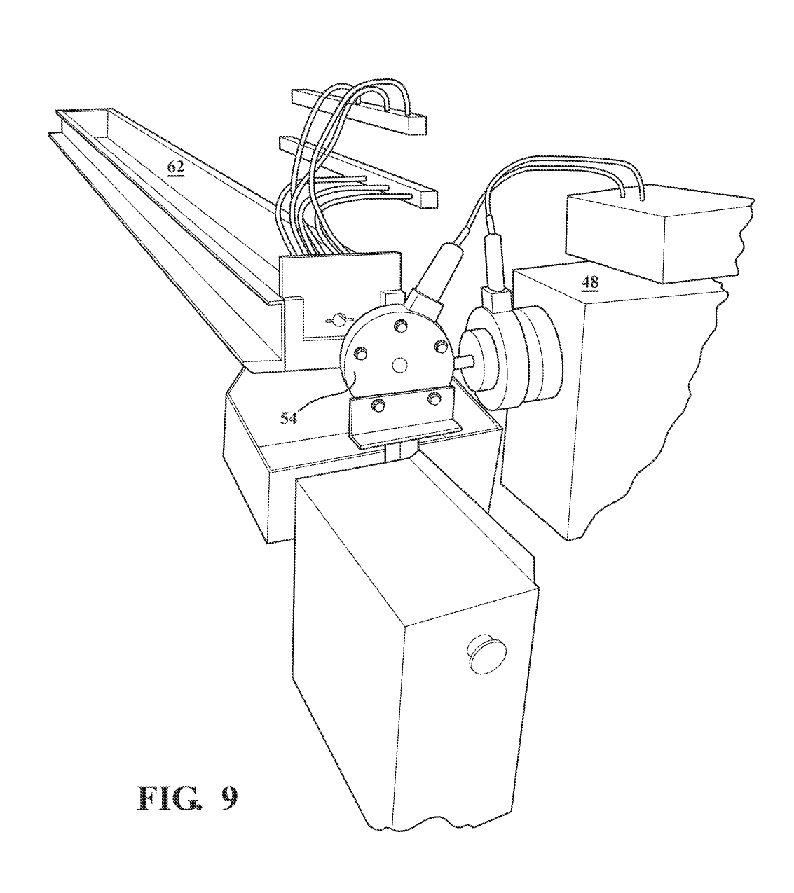

FIG. 9 is a succeeding environmental illustration upstream of the third cross head extrusion die 54 (supplied by corresponding extruder station 48), and for forming the pair of lateral wings 34 and 36 upon the outer concentric tube 32, such providing support for attached wiring associated with the electric drive motor 18, as well as facilitating securing of the injection molded end cap 12 and motor carrier 14 as depicted in FIGS. 4A-4E. Additionally and optionally extruded at this stage is the tab 38 (FIG. 10D) which, in use, provides mounting/positioning support for the flex shaft cover when installed within the vehicle interior. Also shown in perspective view is the third cross head die 54 as well as the final fluid cooling tank 62. Following completed extrusion and cooling/setting of the article depicted at FIG. 10D, each of end stage puller 64 and succeeding cutter 66 operations are provided for sectioning the completed extrusion into desired lengths for incorporation into the vehicle motor bracket assembly (see again directional protocol of FIG. 1).

Although not shown, a separate punching or aperturing operation is provided for forming the holes (see at 68 in FIG. 2) into the extending wings 34/36, such as for receiving wiring or zip ties for supporting the electrical connections from the motor 18. The number and arrangement of the formed holes can also be modified from that shown for providing a mounting location for accessory flanges and/or for additional wire harnesses and the like. Additional end apertures (see rectangular shaped at 70) can also be formed into the wings 34/36 in order to secure the flex shaft cover within the vehicle interior).

Aspects of the present design include the extruded flex-shaft cover 32-36 with structural cross section connecting the two standard injection molded end caps 12/14. The extrusion can then be cut to length for various vehicle packaging requirements and can also be filled with any sound/vibration dampening material for achieving improved sound (attenuation) qualities.

Additional aspects include the provision of the snap features in the end caps (see again as previously described in FIG. 4E) for allowing assembly without tools. As further described and shown, both end caps 12 and 14 utilize the same snap features for eliminating tube orientation concerns for the completed article (again FIG. 4B). The extrusion cross section shown can also be modified from that shown within the scope of the invention and in order to provide any desired characteristics of strength, stiffness and the like.

Having described our invention, other and additional preferred embodiments will become apparent to those skilled in the art to which it pertains, and without deviating from the scope of the appended claims.

We claim:

1. A method for extruding of an article exhibiting an open interior, comprising the steps of:
receiving, in a first stage, an inner sleeve and extruding around the sleeve a surrounding sleeve and a plurality of radially projecting portions;
extruding, in a second stage, an outer circular sleeve about the radially projecting portions; and
extruding, in a third stage, at least one wing portion to an outer edge of the outer circular sleeve.

2. The method as described in claim 1, further comprising the step of pre-extruding the inner sleeve of a nylon material.

3. The method as described in claim 1, further comprising the step of cooling the article at a station succeeding each individual extrusion stage.

4. The method described in claim 1, further comprising the step of vacuum sizing via a sizing tube within which is passed the outer sleeve extrusion following the second stage extrusion.

5. The method as described in claim 1, further comprising the step of pulling the article after the third stage extrusion via a puller station.

6. The method as described in claim 5, further comprising the step of sectioning the article into desired lengths following the puller station via a cutter operation.

7. The method as described in claim 1, said third stage extrusion further comprising the step of extruding a pair of opposite extending wing portions.

8. The method as described in claim 7, further comprising the step of configuring a plurality of apertures within each of the wing portions.

9. The method as described in claim 1, said third stage extrusion further comprising the step of extruding a mounting support tab to an exterior of the outer circular sleeve.

10. The method as described in claim 1, further comprising the step of forming the inner sleeve being from a Nylon 12 material.

11. The method as described in claim 1, further comprising the step of providing each of the first, second and third stage extrusions with a 40% calcium polypropylene material.

12. An assembly for extruding an elongated article exhibiting an open interior, comprising the steps of:
a first stage extruder having a first cross head die for receiving an inner sleeve and extruding around the sleeve a surrounding sleeve along with a plurality of radially projecting portions;
a second stage extruder having a second cross head through which is received the inner sleeve, surrounding sleeve and radially projecting portions, said second stage extruder extruding an outer circular sleeve about the radially projecting portions; and
a third stage extruder extruding at least one wing portion to an outer edge of the outer circular sleeve.

13. The assembly as described in claim 12, further comprising a fourth extruder located prior to the first extruder for extruding the inner sleeve of a nylon material.

14. The assembly as described in claim 12, further comprising a cooling station located at an outlet of each succeeding extruder.

15. The assembly described in claim 12, further comprising a vacuum sizing operation within which is passed the outer sleeve extrusion following the second stage extrusion.

16. The assembly as described in claim 12, further comprising a puller station for withdrawing the article following the third stage extrusion.

17. The assembly as described in claim 16, further comprising a cutter operation succeeding the puller station for sectioning the article into desired lengths.
